(19) United States
(12) Patent Application Publication
(10) Pub. No.: US 2019/0170195 A1
(43) Pub. Date: Jun. 6, 2019

(54) COMPRESSION MODE FLEXIBLE COUPLINGS

(71) Applicant: Jerry L. Hauck, Broussard, LA (US)

(72) Inventor: Jerry L. Hauck, Broussard, LA (US)

(21) Appl. No.: 15/829,691

(22) Filed: Dec. 1, 2017

(51) Int. Cl. F16D 3/10; F16D 3/50

(52) U.S. Cl. CPC F16D 3/10; F16D 3/50

(57) ABSTRACT

A flexible coupling having first and second hubs and a split wrap-around torque transmitting flexible insert. Teeth of the first hub occupy every other receptacle of the flexible insert, and the teeth of the second hub occupy the remaining receptacles of the flexible insert so as to yield a coupling which operates in compression mode wherein the flexible insert can be removed from an installed position by unwrapping it from the hubs without disturbing the position of the hubs.

### BACKGROUND OF THE DISCLOSURE

### Field of the Disclosure

This disclosure relates to new and improved flexible couplings and, more particularly, to an improved flexible coupling which operates in compression mode and features a wrap-around flexible insert which can be removed and replaced without moving hub components with which the flexible insert interacts.

### Description of Related Art

Flexible couplings have long been used for the purpose of transmitting rotation from one shaft to another. Such couplings are normally used in order to accommodate comparatively minor shaft alignment problems such as are occasionally encountered because of manufacturing or assembly errors or equipment tolerances.

### SUMMARY

The following is a summary of various aspects and advantages realizable according to various aspects of the disclosure. It is provided as an introduction to assist those skilled in the art to more rapidly assimilate the detailed design discussion which ensues and does not and is not intended in any way to limit the scope of the claims which are appended hereto in order to particularly point out the invention.

Accordingly, described hereafter is coupling apparatus comprising first and second hubs, each having a cylindrical segment and a plurality of projecting teeth and a flexible insert wrappable around the first and second hubs and having a plurality of interior projections defining a plurality of receptacles for receiving the hub teeth. A retainer ring is removably attachable about the flexible insert to hold it in an installed position about the first and second hubs.

According to an illustrative embodiment, the number of teeth projecting from the first hub is the same as the number of teeth projecting from the second hub, and the flexible insert has a number of receptacles equal to the total number of hub teeth. According to this embodiment, the teeth of the first hub occupy every other receptacle of the insert, and the teeth of the second hub occupy the remaining receptacles of the insert, such that the teeth of the first hub alternate with those of the second hub around a circumference of the flexible insert, yielding a coupling which operates in compression mode.

According to one embodiment, the insert is split so as to facilitate a wrap-around installation and removal procedure with respect to the cooperating first and second hub components. According to this procedure, the first and second hubs are installed in place on respective opposing shafts and properly aligned prior to installation of the insert. The flexible insert is then wrapped around the teeth of the installed first and second hubs. The retaining ring is then slid over the insert, encapsulating the insert so as to hold it in engagement with the hub teeth. The flexible insert can then be easily replaced by simply sliding back the retaining ring, unwrapping the installed insert, replacing it with a new insert, and re-installing the retaining ring.

### BRIEF DESCRIPTION OF THE DRAWINGS

FIG. 1 is an exploded perspective of a flexible coupling according to a preferred embodiment;

FIG. 2 is a perspective view of the coupling in the assembled state;

FIG. 3 is a perspective view of a hub component of the illustrative embodiment;

FIG. 4 is a side sectional view of the hub component taken at IV-IV of FIG. 3;

FIG. 5 is an end view of the hub component of FIG. 3;

FIG. 6 is an end view of a flexible insert component of the illustrative embodiment;

FIG. 7 is an end view of a retainer ring component of the illustrative embodiment; and

FIG. 8 is a side cross-sectional view of the illustrative embodiment taken at VIII-VIII of FIG. 2.

### DETAILED DESCRIPTION OF PREFERRED OF PREFERRED EMBODIMENTS

The coupling 11 of the illustrative embodiment includes a first hub 13, a flexible insert 15, a second hub 17 and a retainer ring 19. In the illustrative embodiment, the first and second hubs 13, 17 are identically shaped and have a plurality of teeth 21 projecting horizontally therefrom. The flexible insert 15 has a circular outer perimeter and a plurality of vertically depending interior projections 23, which define a plurality of receptacles 25 for receiving respective teeth 21.

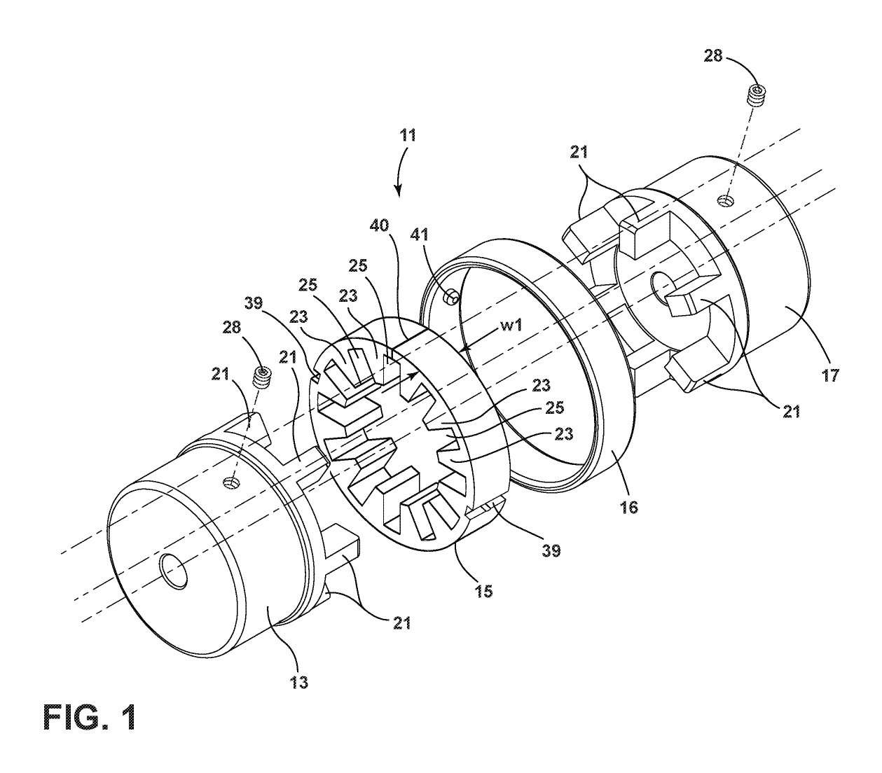

In the illustrative embodiment of FIG. 1, the number of receptacles formed in the flexible insert 15 is twice the number of teeth 21 formed on one of the hubs 13, 17. For example, in the embodiment of FIG. 1, each hub has six teeth 21, and the flexible insert 15 has twelve receptacles 25. When assembled, the teeth 21 of the first hub 13 occupy every other receptacle 25, and the teeth 21 of the second hub 17 occupy the remaining receptacles 25, such that the teeth 21 of the first hub 13 alternate with those of the second hub 17 as one proceeds around the circumference of the flexible insert 15. The number of teeth 21 and receptacles 25 may vary in various other embodiments.

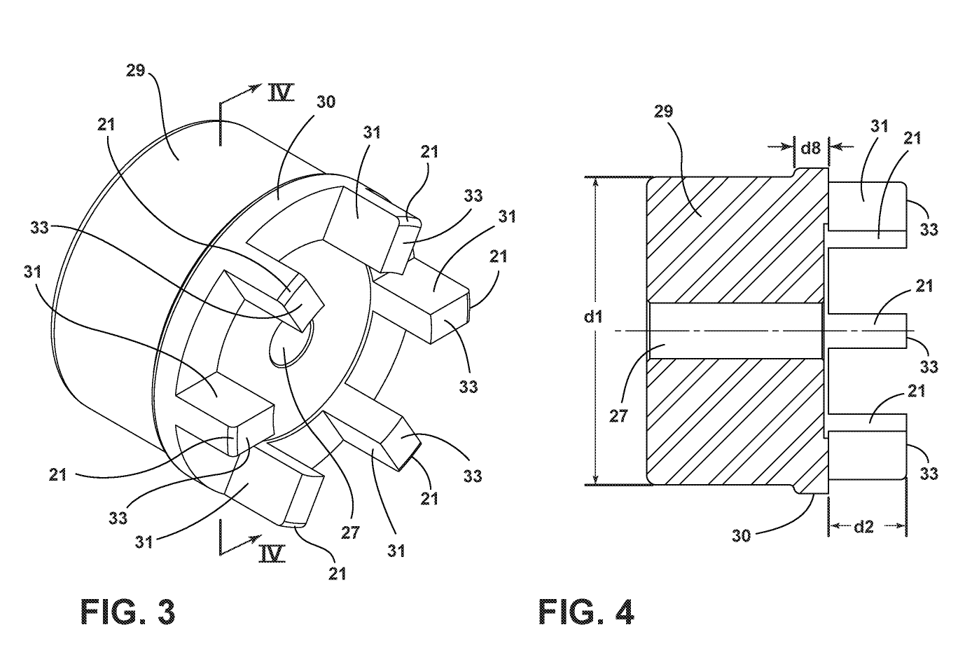

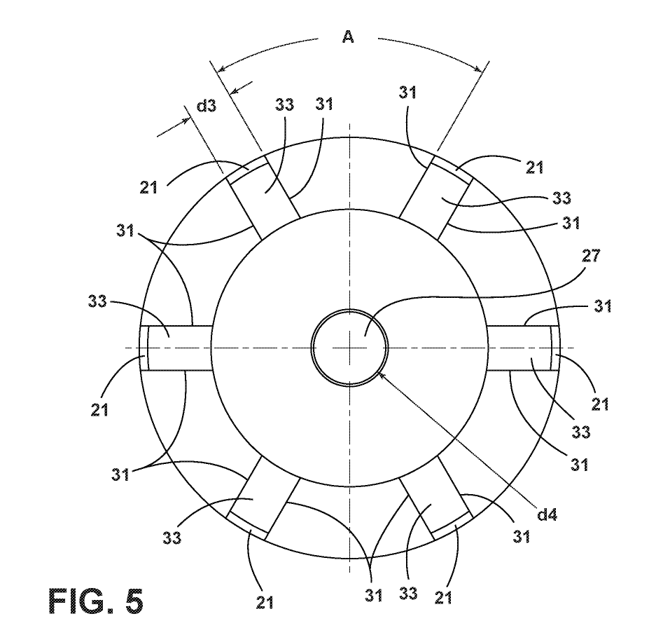

As shown in FIGS. 3-5, in the illustrative embodiment, each hub 13, 17 includes an interior bore 27, a first cylindrical segment 29 of a first diameter d1, and a second cylindrical segment 30 of a larger second diameter and having a width d8. A number of teeth 21 are unitarily formed with the cylindrical segment 30, each projecting a selected distance d2 from its outer perimeter. Each tooth 21 has parallel rectangular side surfaces 31 and a rectangular end 33.

Conventional fastening devices such as set screws 28 may be used to secure the hubs 13, 17 to respective shafts of cooperating apparatus. In the illustrative embodiment, the hubs 13, 17 may have dimensions d1, d2, d3, d4 and d8 in inches of respectively 2.3700, 0.6000, 0.2646, 0.4300, and 0.2650. Such dimensions will of course vary in other embodiments. In the illustrative embodiment, the teeth 21 are equally spaced around the circumference of each hub 13, 17, separated by an angle of 60 degrees from one another. Each hub 13, 17 is preferably machined as a unitary part from a single piece of metal stock, but of course could be constructed in various other fashions.

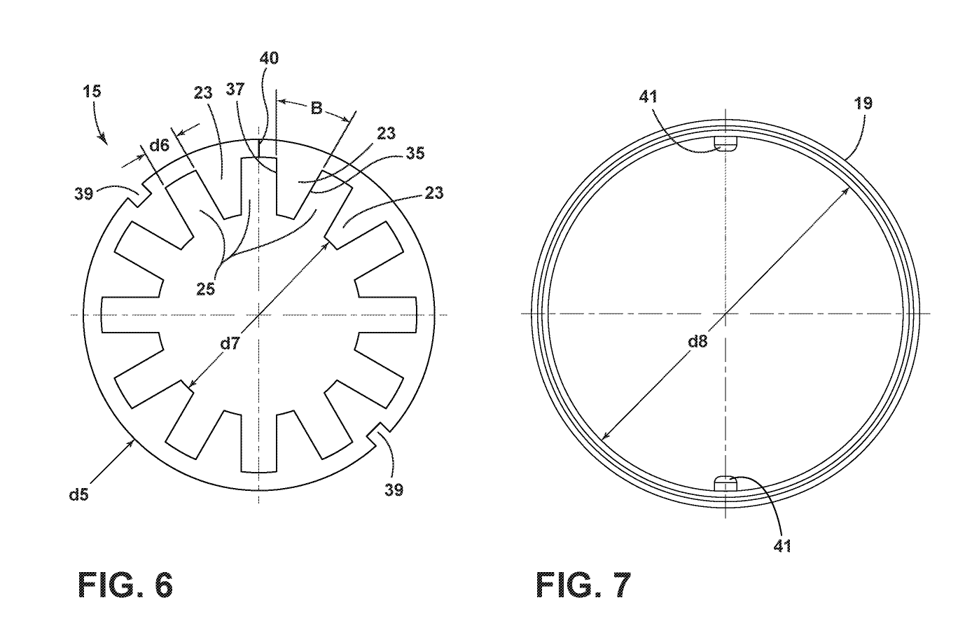

The flexible insert 15 is further illustrated in FIG. 6 and is preferably fabricated from a flexible material such as, for example, a suitable urethane, such as polyurethane. The insert 15 preferably includes a split 40 so as to facilitate “wraparound” installation as further described below.

In one embodiment, the projections 25 depending from the interior surface of the insert 15 are identically shaped and are formed about equally spaced radii extending from the center of the insert 15. In one embodiment, the inner diameter d7 may be 1.6500 inches. The angle B formed by the respective sides, e.g. 35, 37, of each projection 25 is thirty degrees in the illustrative embodiment, but may differ in other embodiments. The receptacles 25 defined by the projections 23 may be rectangular in cross-section d6, which may be 0.2850 inches in the illustrative embodiment, but may differ in other embodiments. In such an embodiment, the overall diameter d5 of the insert 15 is 2.850 inches, but may also differ in other embodiments. Oppositely disposed grooves 39 are formed on the outer surface of the insert 15 to accommodate retainer pins 41 formed on the interior of the retainer ring 19, whose inside diameter d8 (FIG. 7) may be 2.880 inches in the illustrative embodiment.

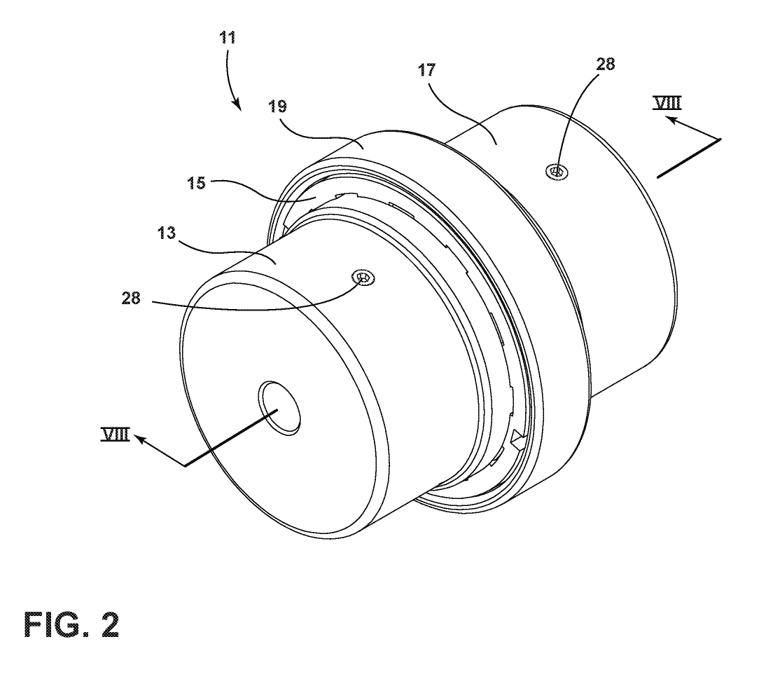

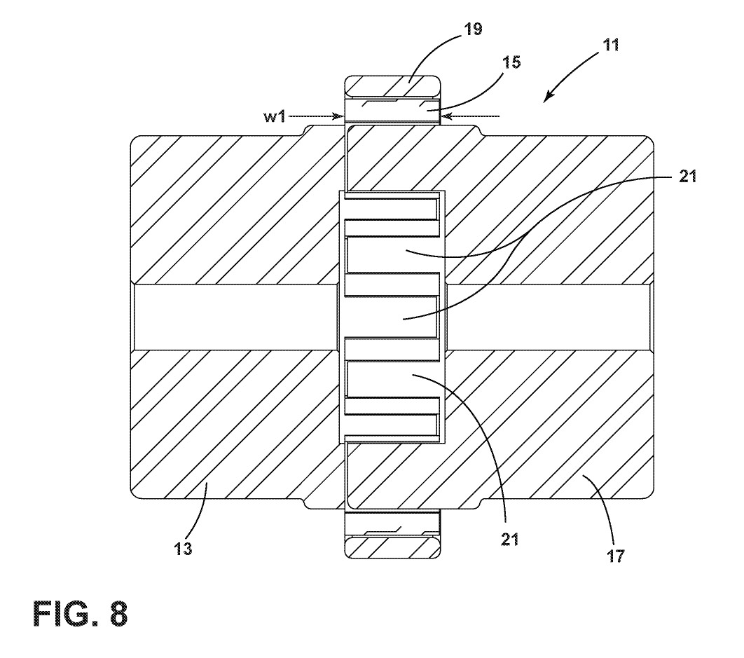

In operation in the assembled state (FIGS. 2, 8), the flexible insert 15 is snugly encased and transmits torque and absorbs minor misalignments. Each projection 25 of the flexible insert 15 is entirely encased between a face of a tooth 21 of the first hub 13 and a face of a tooth 21 of the second hub 17, as illustrated, for example, in FIG. 8. In the illustrative embodiment, the width W1 of the insert 15 is the same as the width of each receptacle 25 and each projection 23. The width W1 is selected in one embodiment such that the teeth 21 of a respective hub 13, 17 completely fill each respective receptacle 25, but are spaced apart so as not to contact the oppositely disposed hub 17, 13, as illustrated in FIG. 8. The coupling 11 operates in compression mode, while enabling the flexible insert 15 to be removed for replacement without disturbing the position of the hubs 13, 17 and without requiring the detachment of the hubs 13, 17 from their cooperating shafts.

To install the coupling 11, the hubs 13, 17 are fastened to respective shafts on the driving and driven sides employing, for example, the respective set screws 28. Each of the shaft hubs 13, 17 can be installed respectively on the driving and driven sides and then moved into place and aligned. The insert 15 and ring 16 are then installed. The urethane insert 15 is cut in one place, so that it can be wrapped around the installed shaft hubs 13, 17, and the retaining ring 16 can then be slid over the outside diameter of the insert 15. If the insert 15 needs replacement, the ring 16 can be slid off the insert 15, and the insert 15 can thereafter be unwrapped and replaced.

While the present invention has been described above in terms of specific embodiments, it is to be understood that the invention is not limited to the disclosed embodiments. Thus, the present invention is intended to cover various modifications and equivalent methods and structures included within the spirit and scope of the appended claims.

1. A coupling apparatus comprising:
a first hub having a cylindrical segment and a plurality of teeth projecting therefrom;
a second hub having a cylindrical segment and a plurality of teeth projecting therefrom;
a flexible insert adapted to be positioned between the first and second hubs and having a circular outer perimeter and a plurality of interior projections defining a plurality of receptacles;
a retainer shaped to be removably attachable around the circular outer perimeter of the flexible insert;
wherein the number of teeth projecting from the first hub is the same as the number of teeth projecting from the second hub; wherein the insert has a number of receptacles equal to twice the number of teeth of the first hub; and wherein the teeth of the first hub are configured to occupy every other receptacle of the insert, while the teeth of the second hub are configured to occupy the remaining receptacles of the insert, such that, when the first hub, second hub, and insert are assembled together, the teeth of the first hub alternate with those of the second hub around a circumference of the flexible insert; and
wherein the insert is split so as to facilitate wrap around installation of the insert onto the first and second hubs and so as to further facilitate removal of an installed insert from the first and second hubs when the first and second hubs are attached to respective shafts without moving the first and second hubs.

2. The coupling apparatus of claim 1 wherein the number of teeth on each hub is six and the number of receptacles is twelve.

3. The coupling apparatus of claim 1 wherein the teeth of the first and second hubs each have planar side surfaces configured to capture such that each projection of the insert is captured between a tooth of one the first hub and a tooth of the second hub whereby the coupling apparatus when assembled operates in compression mode.

4. The coupling apparatus of claim 1 wherein the teeth of the first and second hubs and the interior projections of the flexible insert are shaped and dimensioned to achieve compression mode operation of the coupling apparatus when assembled.

5. A flexible coupling comprising:
first and second hubs each having a plurality of teeth;
a wrap-around torque transmitting flexible insert having a plurality of receptacles; and
wherein the teeth of the first hub occupy every other receptacle of the flexible insert, and the teeth of the second hub occupy the remaining receptacles of the flexible insert, such that the teeth of the first hub alternate with those of the second hub around a circumference of the flexible insert, the teeth and receptacles being so shaped and dimensioned that the flexible coupling operates in compression mode.

6. The flexible coupling of claim 5 wherein the flexible insert is split so as to facilitate wrap around installation of the insert onto the first and second hubs and so as to further facilitate removal of an installed insert from the first and second hubs when the first and second hubs are attached to respective shafts without moving the first and second hubs.

7. The coupling of claim 5 wherein the number of teeth on each hub is six and the number of receptacles is twelve.

8. The coupling of claim 5 wherein the teeth of the first and second hubs each have planar side surfaces such that each projection of the flexible insert is captured between a tooth of one hub and a tooth of the second hub whereby the coupling operates in compression mode.

9. The coupling of claim 5 wherein the plurality of receptacles are defined by a plurality of interior projections of the flexible insert and wherein the teeth of the first and second hubs and the interior projections of the flexible insert are shaped and dimensioned to achieve compression mode operation of the coupling.

10. The flexible coupling of claim 8 wherein the flexible insert is split so as to facilitate wrap around installation of the insert onto the first and second hubs and so as to further facilitate removal of an installed insert from the first and second hubs when the first and second hubs are attached to respective shafts without moving the first and second hubs.

11. The flexible coupling of claim 5 wherein the number of teeth projecting from the first hub is the same as the number of teeth projecting from the second hub; wherein the insert has a number of receptacles equal to twice the number of teeth of the first hub such that the teeth of the first hub alternate with those of the second hub around a circumference of the flexible insert.

12. The flexible coupling of claim 5 wherein the teeth of each hub are equally spaced around a circumference of the respective hub.

13. The flexible coupling of claim 12 wherein each tooth of the first hub is separated by an angle of 60 degrees from an adjacent tooth of the first hub and each tooth of the second hub is separated by an angle of 60 degrees from an adjacent tooth of the second hub.

14. The flexible coupling of claim 5 wherein each of the first and second hubs is machined from a single piece of metal stock.

15. The flexible coupling of claim 8 wherein each projection of the flexible insert is entirely encased between a face of a tooth of the first hub and a face of a tooth of the second hub.

16. The flexible coupling of claim 8 wherein a width of the insert is the same as a width of each receptacle and each projection.

17. The flexible coupling of claim 16 wherein the width of the insert is selected such that the teeth of a respective hub completely fill each respective receptacle, but do not to contact the oppositely disposed hub.

18. The flexible coupling of claim 5 further comprising a retainer ring configured to hold the flexible insert engaged with the first and second hubs in an assembled state.

19. The flexible coupling of claim 5 wherein each tooth of each of the first and second hubs has parallel rectangular side surfaces and a rectangular end.
